(19) United States
(12) Patent Application Publication
(10) Pub. No.: US 2010/0042801 A1
(43) Pub. Date: Feb. 18, 2010

(54) Apparatus and method for reallocation of memory in a mobile communication terminal

(75) Inventors: Jeong-Eun Lee, Seongnam-si (KR); Young-Seop Han, Suseong-gu (KR); Dae-Hyun Sim, Seocho-gu (KR); Sung Kwon, Anyang-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/583,233

(22) Filed: Aug. 17, 2009

(30) Foreign Application Priority Data
Aug. 18, 2008 (KR) 10-2008-0080300

(51) Int. Cl. G06F 12/02; G06F 12/00

(52) U.S. Cl. 711/171; 711/E12.001; 711/E12.002

(57) ABSTRACT

A mobile terminal includes an apparatus for reallocating memory. The apparatus is configured to determine whether an available memory capacity is less than a threshold value. The apparatus further generates a memory reallocation scenario based on a terminal usage history for each application if the available memory capacity is less than the threshold value.

### CROSS-REFERENCE TO RELATED APPLICATION(S) AND CLAIM OF PRIORITY

The present application is related to and claims priority under 35 U.S.C. § 119(a) to a Korean Patent Application filed in the Korean Intellectual Property Office on Aug. 18, 2008 and assigned Serial No. 10-2008-0080300, the contents of which are herein incorporated by reference.

### TECHNICAL FIELD OF THE INVENTION

The present invention relates to an apparatus and a method for reallocation of memory in mobile communication terminal. More particularly, the present invention relates to an apparatus and a method for effective reallocation of memory based on a terminal usage history, such as a usage history for each application, a memory usage history for each application and an option setting history for each application by user, in mobile communication terminal.

### BACKGROUND OF THE INVENTION

The use of mobile communication terminals is wide spread because of their portability, and service providers and terminal manufacturers have made an effort to develop mobile communication terminals with more convenient functions for the purpose of attracting potential users. For example, mobile communication terminals provide a variety of additional functions and services, such as a phone book function, a game function, a Short Message Service (SMS), an Internet service, an e-mail service, a morning call function, a file viewer function, a file transfer function, an auto answering function, a camera function and so forth.

As providing various additional functions and services, there are various applications corresponding to the functions and services in the mobile communication terminal. For example, the applications include a text message service, a Multimedia Message Service (MMS), a file manager function, an e-mail service, a camera function, a video recorder function, a voice recorder function, a media player function, a memo function, a scheduling function, a tasking function, an anniversary notifying function and so on. Use of specific applications depends on a user preference. The mobile communication terminals allocate memory according to each application respectively. By detecting memory state information among a set of information in a mobile communication terminal, user may detect an allocated memory capacity and an available memory capacity for each application.

The memory capacity for each application of the mobile communication terminal is limited. Thus, when available memory capacity for specific application is less than the file capacity intended to be newly saved in mobile communication terminal, the mobile communication terminal may not store the new file because of lack of the available memory capacity for that application. In this case, the user has to delete existing files for storing the new file. Also, the allocated memory capacity of specific application frequently used by user is likely to be lack. And memory capacity of application infrequently used is likely to be unused. Therefore, there is a need to provide an efficient memory management method and apparatus depending on the frequency of use of specific application.

### SUMMARY OF THE INVENTION

To address the above-discussed deficiencies of the prior art, it is a primary an aspect of the present invention is to substantially address at least the above problems and/or disadvantages and to provide at least the advantages below. Accordingly, one aspect of the present invention is to provide an apparatus and a method for reallocation of memory in mobile communication terminal.

Another aspect of the present invention is to provide an apparatus and a method for effective reallocation of memory based on a terminal usage history, such as a usage history for each application, a memory usage history for each application and an option setting history for each application by user, in mobile communication terminal.

A further aspect of the present invention is to provide an apparatus and a method for efficient memory managing and maximized memory use by user in mobile communication terminal.

The above aspects are achieved by providing an apparatus and a method for reallocation of memory in mobile communication terminal.

According to one aspect of the present invention, a method for reallocation of memory in mobile communication terminal with a plurality of applications, the method comprising: determining whether an available memory capacity is less than a threshold value; and generating memory reallocation scenario based on a terminal usage history for each application if the available memory capacity is less than the threshold value.

According to another aspect of the present invention, an apparatus for reallocation of memory in mobile communication terminal with a plurality of applications, the apparatus comprising: a memory for storing a terminal usage history for each application; and a memory reallocation unit for determining whether an available memory capacity is less than a threshold value; and generating memory reallocation scenario based on a terminal usage history for each application if the available memory capacity is less than the threshold value.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a mobile communication terminal according to an exemplary embodiment of the present invention;

FIG. 2 illustrates a method for reallocation of memory in mobile communication terminal according to an exemplary embodiment of the present invention; and

FIG. 3 illustrates a method for generating of memory reallocation scenario in mobile communication terminal according to an exemplary embodiment of the present invention.

### DETAILED DESCRIPTION OF THE PREFERRED EMBODIMENTS

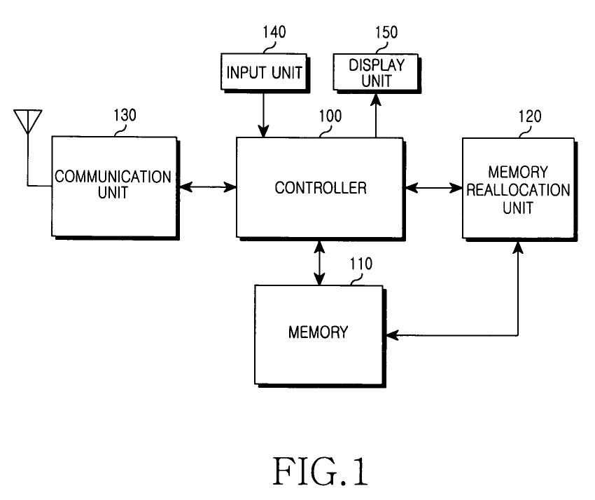

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system.

A scheme for effective reallocation of memory based on a terminal usage history, such as a usage history for each application, a memory usage history for each application and an option setting history for each application by user, in mobile communication terminal according to the present invention is described below.

The usage history for each application of user may include a text message service, a MMS, a file manager function, an e-mail service, a camera function, a video recorder function, a voice recorder function, a media player function, a memo function, a scheduling function, a tasking function, an anniversary notifying function and so forth. Also the memory usage history for each application may include various applications such as an inbox for a text message service, a outbox for a text message service, an inbox for a MMS, an outbox for a multimedia message service, a file manager function, an inbox for an e-mail service, a phone book function, an organizer function (i.e., for a memo function, a scheduling function, a tasking function and an anniversary notifying function) and so forth. Also, user may set options such as a size of a message, a size of a file, the number of stored transmissions/receptions, a size of a picture and so forth in a memory.

FIG. 1 illustrates a mobile communication terminal according to an exemplary embodiment of the present invention.

As illustrated in FIG. 1, the mobile communication terminal includes a controller 100, a memory 110, a memory reallocation unit 120, a communication unit 130, an input unit 140 and display unit 150.

Referring to FIG. 1, the controller 100 controls and processes overall operations of the terminal. More particularly, the controller 100 controls and processes a function of for reallocation of memory based on a terminal usage history, such as a usage history for each application, a memory usage history for each application and an option setting history for each application by user according to the present invention.

The memory 110 stores programs used for overall operations of the terminal and a variety of information. More particularly, the memory 110 stores and manages a terminal usage history, such as a usage history for each application, a memory usage history for each application and an option setting history for each application by user according to the present invention. The terminal usage history may be divided according to current time or a position of user, or a schedule of user or an event of user. That is, the memory 110 may store not only a normal terminal usage history, but also terminal usage history divided according to current time or a position of user, or a schedule of user or an event of user. Herein, the normal terminal usage history means a terminal usage history irrelevant to current time or a position of user, or a schedule of user or an event of user. Also in the memory, information of each application and condition are additionally added. The information for each application is a data for extraction of a terminal usage history. The information for each application, for example, includes use information for each application and information of unit memory (i.e. the minimum memory) for each application. The information for the condition includes current time or a position of user, or a schedule of user or an event of user.

The memory reallocation unit 120 extracts the terminal usage history of user from the memory 110, generates a memory reallocation scenario based on the extracted terminal usage history and reallocates the memory 110 according to the memory reallocation scenario. The terminal usage history may be enlisted by ranking according to the frequency of use. For example the usage history for each application may list the applications depending on frequency of use by ranking. Also, the memory usage history for each application may list the applications of a memory depending on frequency of use by ranking, or the applications depending of required memory capacity by ranking. Also, the option setting history for each application may list the applications depending on frequency of option setting by ranking.

The communication unit 130 processes a signal transmitted and received through an antenna.

The input unit 140 includes a plurality of function keys to provide the controller 100 with data corresponding to a key pressed by a user.

The display unit 150 displays state information, numeric characters, alphabetic characters, and the like which are generated during the operation of the terminal.

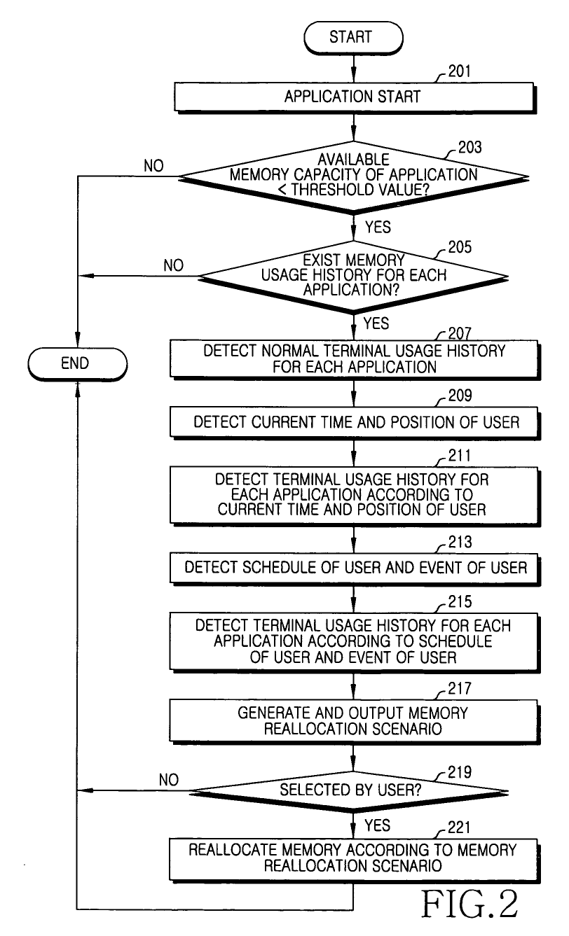

FIG. 2 illustrates a method for reallocation of memory in mobile communication terminal according to an exemplary embodiment of the present invention.

Referring to FIG. 2, in step 201, the terminal starts an application requiring a use of memory.

Then, in step 203, the terminal determines whether an available memory capacity of the application is less than a threshold value. If the available memory capacity of the application is less than the threshold value in step 203, the terminal in step 205 determines whether a memory usage history for each and every application by user exists. Conversely, if the available memory capacity of the application is not less than the threshold value in step 203, the terminal terminates the procedure of the present invention. In another embodiment, if the available memory capacity of the application is not less than the threshold value in step 203, the terminal may reallocate an available memory for each application according to a predetermined method.

If the memory usage history for each and every application by user exists in step 205, in step 207, the terminal detects a normal terminal usage history, stored in a memory, for each application. Herein, the normal terminal usage history means a terminal usage history (i.e., a usage history for each application, a memory usage history for each application and an option setting history for each application by user) irrelevant to a current time or a position of user, or a schedule of user or an event of user. Conversely, if the memory usage history for each and every application by user does not exist in step 205, the terminal terminates the procedure of the present invention.

Then, in step 209, the terminal detects a current time and a position of user.

Then, in step 211, the terminal detects a terminal usage history according to the current time and the position of user, for each application. That is, the terminal detects a usage history for each application, a memory usage history for each application and an option setting history for each application by user according to the current time and the position of user. The current time means a specific time in a day or a specific day in a month.

Then, in step 213, the terminal detects a schedule of user and an event of user.

Then, in step 215, the terminal detects a terminal usage history according to the schedule of user and the event of user, for each application. That is, the terminal detects a usage history for each application, a memory usage history for each application and an option setting history for each application by user according to the schedule of user and the event of user.

Then, in step 217, the terminal generates and outputs a memory reallocation scenario based on the detected terminal usage history to a speaker or a display unit. Therefore, the user may select reallocation of the memory according to the outputted memory reallocation scenario.

Then, in step 219, the terminal determines whether reallocation of the memory is selected by user.

If reallocation of the memory is selected by user in step 219, in step 221, the terminal reallocates the memory according to the memory reallocation scenario. Conversely, if reallocation of the memory is not selected by user in step 219, the terminal terminates the procedure of the present invention.

In another embodiment, the step 201 may be replaced by a power-on of the terminal or starting of another application irrespective of use of memory. In this case, the step 201 may directly go to step 205 without going to step 203.

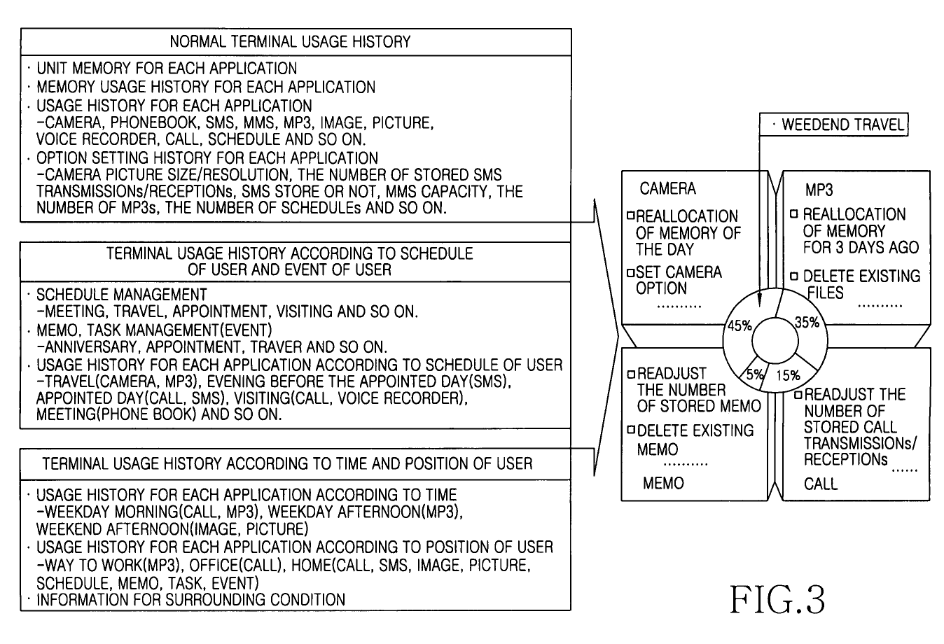

FIG. 3 illustrates a method for generating of memory reallocation scenario in mobile communication terminal according to an exemplary embodiment of the present invention.

Referring to FIG. 3, it is assumed that a usage history for each application includes usage histories for a camera function, a phone book function, a SMS, a MMS, an MP3 function, an image function, a picture function, a voice recorder function, a call service and a scheduling function in a normal terminal usage history detected by the terminal. Also, it is assumed that an option setting history for each application includes a size of a camera picture, a resolution of a camera picture, the number of stored SMS transmissions/receptions, storing a SMS or not, an MMS capacity, the number of MP3s and the number of schedules in a normal terminal usage history detected by the terminal.

Also, it is assumed that a usage history for each application includes a camera function and an MP3 function for ‘travel’, a SMS for ‘evening before the appointed day’, a call service and a SMS for ‘appointed day’, a call service and a voice recorder function for ‘visiting’ and a phone book function for ‘meeting’ in a terminal usage history according to a schedule of user and an event of user detected by the terminal.

Also, it is assumed that a usage history for each application includes a call service and an MP3 function for ‘weekday morning’, an MP3 function for ‘weekday afternoon’, an image function and a photo function for ‘weekend afternoon’ in a terminal usage history according to the current time detected by the terminal.

Also, it is assumed that a usage history for each application includes an MP3 function for ‘way to work’, a call service for ‘office’ and a call service, a SMS, an image function, a photo function, a scheduling function, a memo function, a tasking function and event function for ‘home’ in a terminal usage history according to the position of user detected by the terminal.

If a detected current schedule of user is ‘weekend travel’, the terminal may detect that a terminal usage history includes a camera function, an MP3 function, a memo function and a call service. Then, the terminal may generate a memory reallocation scenario that recommend to set camera option, delete existing memo or delete existing MP3 files and photos based on the detected terminal usage history. Also, the terminal may generate a memory reallocation scenario that recommend to reduce capacity of existing MP3 files and photos, to increase available memory capacity of specific application frequently used by user or to decrease available memory capacity of specific application based on the detected terminal usage history.

Meanwhile in case of detecting great change on usage history for each application, time or position of user, or when user intends to operate specific application under lack of available memory capacity of the specific application the terminal may generate a memory reallocation scenario as apply to an exemplary embodiment of the present invention.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for reallocation of memory in mobile communication terminal with a plurality of applications, the method comprising:
determining whether an available memory capacity is less than a threshold value; and
generating memory reallocation scenario based on a terminal usage history for each application if the available memory capacity is less than the threshold value.

2. The method of claim 1, wherein the terminal usage history for each application includes at least one of a usage history for each application, a memory usage history for each application and an option setting history for each application.

3. The method of claim 2, wherein the terminal usage history for each application is classified by at least one of current time, a position of user, a schedule of user and an event of user.

4. The method of claim 3, wherein the terminal usage history for each application is detected by the steps of:
detecting at least one of current time, a position of user, a schedule of user and an event of user; and
detecting a terminal usage history for each application according to at least one of current time, a position of user, a schedule of user and an event of user.

5. The method of claim 1, wherein the step of determining whether an available memory capacity is less than a threshold value is performed when an application requiring a use of memory is started, or the terminal is powered on, or another application irrespective of use of memory is started.

6. The method of claim 1, further comprising:
outputting the memory reallocation scenario to a speaker or a display unit; and
reallocating the memory according to the outputted memory reallocation scenario if reallocation of the memory is selected.

7. The method of claim 1, wherein the memory reallocation scenario recommends at least one of reducing of capacity for existing stored files, deleting of existing stored files, increasing of available memory capacity for specific application frequently used by user and decreasing of available memory capacity for specific application infrequently used by user.

8. The method of claim 1, wherein a terminal usage history for each application is detected by ranking according to the frequency of use.

9. An apparatus for reallocation of memory in mobile communication terminal with a plurality of applications, the apparatus comprising:
a memory for storing a terminal usage history for each application; and
a memory reallocation unit for determining whether an available memory capacity is less than a threshold value; and generating memory reallocation scenario based on a terminal usage history for each application if the available memory capacity is less than the threshold value.

10. The apparatus of claim 9, wherein the terminal usage history for each application includes at least one of a usage history for each application, a memory usage history for each application and an option setting history for each application.

11. The apparatus of claim 10, wherein the terminal usage history for each application is classified by at least one of current time, a position of user, a schedule of user and an event of user.

12. The apparatus of claim 11, wherein the memory reallocation unit detects at least one of current time, a position of user, a schedule of user and an event of user and detects a terminal usage history for each application according to at least one of current time, a position of user, a schedule of user and an event of user.

13. The apparatus of claim 9, wherein the memory reallocation unit determines whether an available memory capacity is less than the threshold value when an application requiring a use of memory is started, or the terminal is powered on, or another application irrespective of use of memory is started.

14. The apparatus of claim 9, further comprising a speaker and/or a display unit for outputting the generated memory reallocation scenario.

15. The apparatus of claim 9, wherein the memory reallocation unit recommends at least one of reducing of capacity for existing stored files, deleting of existing stored files, increasing of available memory capacity for specific application frequently used by user and decreasing of available memory capacity for specific application infrequently used by user.

16. The apparatus of claim 9, wherein a terminal usage history for each application is detected by ranking according to the frequency of use.

17. A mobile communication terminal capable of executing a plurality of applications, the mobile communication terminal comprising:
a memory for storing a terminal usage history for each application; and
a memory reallocation unit for determining whether an available memory capacity is less than a threshold value; and generating memory reallocation scenario based on a terminal usage history for each application if the available memory capacity is less than the threshold value.

18. The mobile communication terminal of claim 17, wherein the terminal usage history for each application includes at least one of a usage history for each application, a memory usage history for each application and an option setting history for each application.

19. The mobile communication terminal of claim 18, wherein the terminal usage history for each application is classified by at least one of current time, a position of user, a schedule of user and an event of user.

20. The mobile communication terminal of claim 19, wherein the memory reallocation unit detects at least one of current time, a position of user, a schedule of user and an event of user and detects a terminal usage history for each application according to at least one of current time, a position of user, a schedule of user and an event of user.
